(19) United States
(12) Patent Application Publication
(10) Pub. No.: US 2002/0105251 A1
(43) Pub. Date: Aug. 8, 2002

(54) Protective work chamber for arts, crafts, and other messy processes

(76) Inventor: Kenneth R. Kensey, Malvern, PA (US)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(21) Appl. No.: 10/050,197

(22) Filed: Jan. 16, 2002

Related U.S. Application Data
(60) Provisional application No. 60/266,049, filed on Feb. 2, 2001.

(51) Int. Cl. A61G 11/00

(52) U.S. Cl. 312/1

(57) ABSTRACT

A protective work chamber for arts, crafts, and other messy processes is provided that includes a container having at least one integral, substantially see-through panel, where the container is constructed at least partially from a flexible material, and has at least one glove having a hand section and an arm section, where the arm section is sealed to the container; and where the container has arts and crafts materials sealed therein.

### CROSS-REFERENCE TO RELATED APPLICATION

This Application Claims the Benefit of U.S. Provisional Application Serial No. 60/266,049 filed on Feb. 2, 2001.

### BACKGROUND OF THE INVENTION

This invention relates generally to the field of arts and crafts for children, and, in particular, to a protective work chamber for arts, crafts, and other messy processes wherein the inside of the chamber is accessible via protective gloves.

Children want to create. For example, children typically want to play with clay, mold things, paint, carve, shape, sculpt, whittle, and the like. However, since the children often make a mess, spreading paints, clays, and other materials over themselves and surrounding areas, parents, teachers, and other caretakers often limit when and where the children can perform these creative functions, thereby possibly stifling the children's creativity.

Additionally, children may cut or otherwise harm themselves or others with certain of the tools used for these projects, particularly in the early learning process of using tools such as knives for whittling

The present invention addresses these issues and others by providing a chamber that houses arts and crafts or other work materials along with tools for use with these materials. Access to the chamber is provided by gloves that are integral to the chamber.

The general concept of gloved boxes and containers is well known. For example, in U.S. Pat. No. 5,671,983 (Miller et al.), a storage bag containing gloves to access the contents of the bag is shown. Here a lockable storage bag includes a receptacle bag, a sealing zipper, and gloves. A workpiece is placed in the receptacle bag and the sealing zipper is closed. The workpiece is protected from the environment but can be manipulated by a hand of a user through a glove that is integral to the bag. Numerous uses are disclosed, including kneading of dough, assembling of small machinery, surgical removing of organs, capturing of evidence, protecting a work product from contamination, loading of film in a camera, protecting against caustic chemicals, and temporarily storing a wet paint brush.

U.S. Pat. No. 6,050,726 (Hoerl) provides a plastic bag constructed to include an integral glove or mitten. The glove extends from a bag surface that permits objects to be gripped and deposited or withdrawn from the bag. A closure seals the bag to contain the collected materials and the soiled surface of the glove inside the bag. A typical use disclosed here is the collection of animal feces.

U.S. Pat. No. 3,354,922 (James) discloses a flexible plastic enclosure for use in preparing food for cooking, such as peeling onions. The enclosure has top, bottom, front, rear, and side walls. The front wall is formed with a pair of spaced round openings. A pair of tubular plastic mittens is included where each mitten has one end secured around one of the openings and extends inwardly to the interior of the enclosure. An operator inserts his hands into the mittens where an onion, a cutting tool and an onion supporting tool are located. The onion is then peeled in the enclosure.

U.S. Pat. No. 5,685,771 (Kleppen) discloses an enclosure that envelopes a work area with an inert gaseous atmosphere that contains gloved access to the enclosure. Here, the enclosure is particularly useful as a welding enclosure for welding metals in a total atmosphere of inert gas. There is a recloseable gas tight opening in the top of the enclosure for introducing workpieces. The hood of the enclosure is collapsible and is inflated with the inert gas. Likewise, U.S. Pat. No. 4,437,710 discloses an inflatable, inert gas filled welding chamber having gloved hands.

U.S. Pat. No. 5,890,781 (Ryder) discloses a portable and/or disposable glove box that comprises a rigid frame that defines the shape of the box. A gloved bag is sealingly fitted over the frame to define a sealed area. Gloves are integral to the glove bag that allow access to the sealed area. This device is particularly useful for handling highly toxic or pharmaceutical substances.

U.S. Pat. No. 5,520,449 (Klak) discloses a glove bag having a zip-loc closure. A pair of gloves is secured to the interior surface of the glove bag. The top portion of the bag has a tab portion having a pressure sensitive adhesive thereon that is folded to provide a double-sealed bag which enhances the sealing of the bag. This bag is specifically designed for asbestos removal. Likewise, U.S. Pat. No. 5,017,197 (McGuire) discloses a glove bag for containing and disposing of asbestos released during work on a pipe section.

U.S. Pat. No. 5,198,523 (Baumann et al.) discloses a box having a housing opening where a gas-tight glove is connected to the container.

U.S. Pat. No. 4,335,712 (Trexler) discloses an enclosure for providing an atmosphere isolated from the ambient environment. This device is particularly useful for isolating human patients with acute infectious diseases. The enclosure has gloved hands extending into the enclosure and has a transfer port for passage of objects out of the enclosure member. A flexible disposal bag is coupled to the enclosure around the transfer point.

### SUMMARY OF THE INVENTION

The present invention provides a protective work chamber for arts, crafts, and other messy processes. The preferred embodiment includes a container having at least one integral, substantially see-through panel and is constructed at least partially from a flexible material. At least one glove having a hand section and an arm section is integral to the container, i.e., the arm section is sealed to the container. The container has arts and crafts materials sealed inside.

The container may be constructed entirely from a see-through flexible material and may be made in any shape, for example that of a sphere. Preferably, the container is inflatable and has a valve attached to an outer surface of the container for inflation and deflation.

The gloves may be constructed at least partially from a material that protects against accidental scrapes and cuts.

The arts and crafts materials may include, for example, paper, clay, wood, or any other working material as well as paint and any type of arts and crafts objects, for example, buttons, pipe cleaners, etc. The arts and crafts materials may also include tools such as paint brushes, knives, etc. A tool holder may be built into a wall of the container to hold the tools out of the way of the work piece.

The container may be permanently sealed such that a knife or scissors is required to gain access to the finished workpiece inside the container. An imprint area for indicia may be located on a wall of the container that provides a space for a trademark. The protective work chamber preferably is capable of containing hazardous odors such as paint and glue fumes. Additionally, rather than for use for arts and crafts, such a container may also be used in an industrial setting and the chamber may be capable of containing an industrial gas.

The protective work chamber may be at least partially made from a heat shrinkable material or may be otherwise deflated such that a portion of the container fits snugly around the finished workpiece such that the workpiece can be displayed within the chamber. A frame, integrally attached to the container, may be included for display purposes.

The chamber may also include means for maintaining various environmental conditions therein, for example, temperature or light.

### DESCRIPTION OF THE DRAWINGS

FIG. 1 is a front, elevation view of a protective work chamber for arts, crafts, and other messy processes in accordance with one preferred embodiment of the present invention;

FIG. 2 is a top, plan view of the protective work chamber for arts, crafts, and other messy processes of FIG. 1;

FIG. 3 is a cross sectional, front elevational view of the protective work chamber for arts, crafts, and other messy processes of FIG. 1;

FIG. 4 is a side, elevational view of the protective work chamber for arts, crafts, and other messy processes of FIG. 1 shown with the chamber in a deflated condition;

FIG. 5 is a cross sectional view of a protective work chamber for arts, crafts, and other messy processes in accordance with an alternate preferred embodiment of the present invention;

FIG. 6 is a front, elevational view of a protective work chamber for arts, crafts, and other messy processes in accordance with a second alternate preferred embodiment of the present invention; and

FIG. 7 is a top plan view of a protective work chamber for arts, crafts, and other messy processes in accordance with a third alternate preferred embodiment of the present invention.

### DETAILED DESCRIPTION OF THE PREFERRED EMBODIMENT

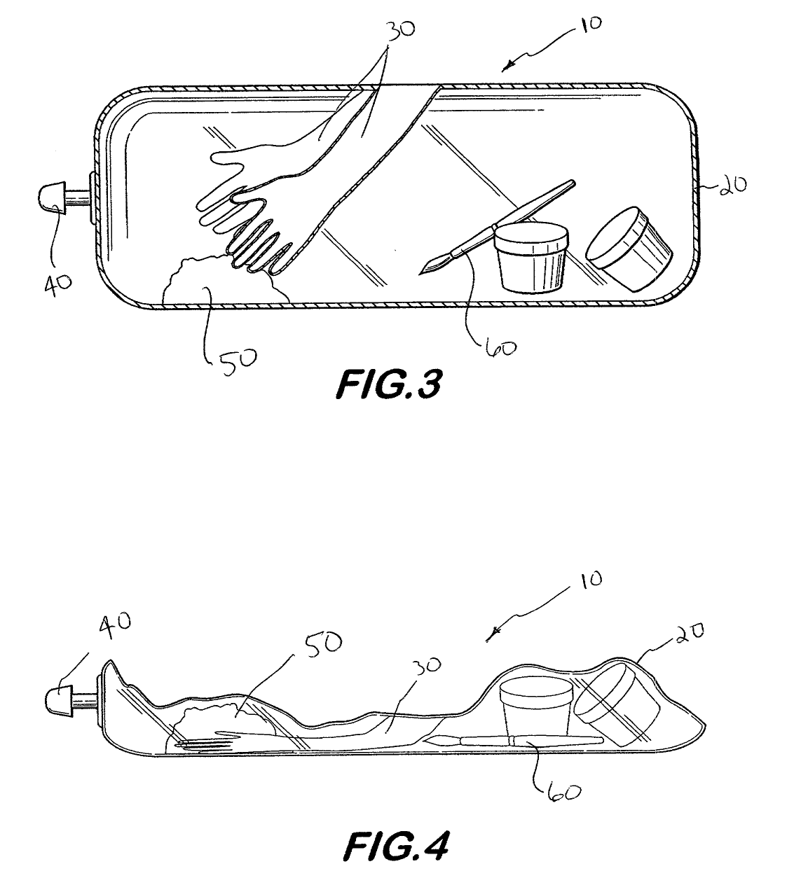

Referring now to the various figures of the drawing wherein like reference numbers refer to like parts throughout the several views, there is shown in FIGS. 1 through 4 a protective work chamber for arts, crafts, and other messy processes 10 in accordance with one preferred embodiment of the present invention. The protective work chamber 10 generally includes a container 20, made, at least partially, from a flexible material, a pair of gloves 30 integral to the container 20, and a valve 40 also integral to the container 20. The container 20 may be all, or at least partially, transparent such that objects inside the container 20 may be viewed from outside the container 20. Sealed inside the container 20 are work materials 50 such as paper, clay, a block of wood, paints, or anything else known in the arts and crafts field that is capable of fitting and being accessed inside the chamber 10. Optionally, tools 60, such as paintbrushes, knives, Q-tips, and the like, for use on the arts and crafts materials may also be included within the container 20.

As depicted in FIG. 4, during shipping, display on store shelves, storage, and the like, the chamber 10 is preferably in a deflated condition to minimize shelf and storage space and shipping costs. The work materials 50 and tools 60 are sealed within the deflated container 20. When a user desires to use the chamber 10, the user inflates the container 20 via valve 40, inserts his or her hands into the integral gloves 30 of the chamber 10, picks up one or more tools 60 if desired, and begins work on the work materials 50. For example, a user can form the clay into a shaped article with his hands or tools with any residual debris falling adjacent the article, but contained within the container 20. If the work materials 50 include glue or paints or other substances where fumes are created, any fumes created thereby are contained within the container 20 while the work piece is being formed. This is particularly advantageous when the chamber 10 is used in a confined area such as a car.

Once the arts and crafts materials are used to create an article that is to the user's satisfaction, the container 20 may be cut opened and the article may be removed for, for example, drying, baking, and the like. The remaining tools and the debris can be properly disposed of.

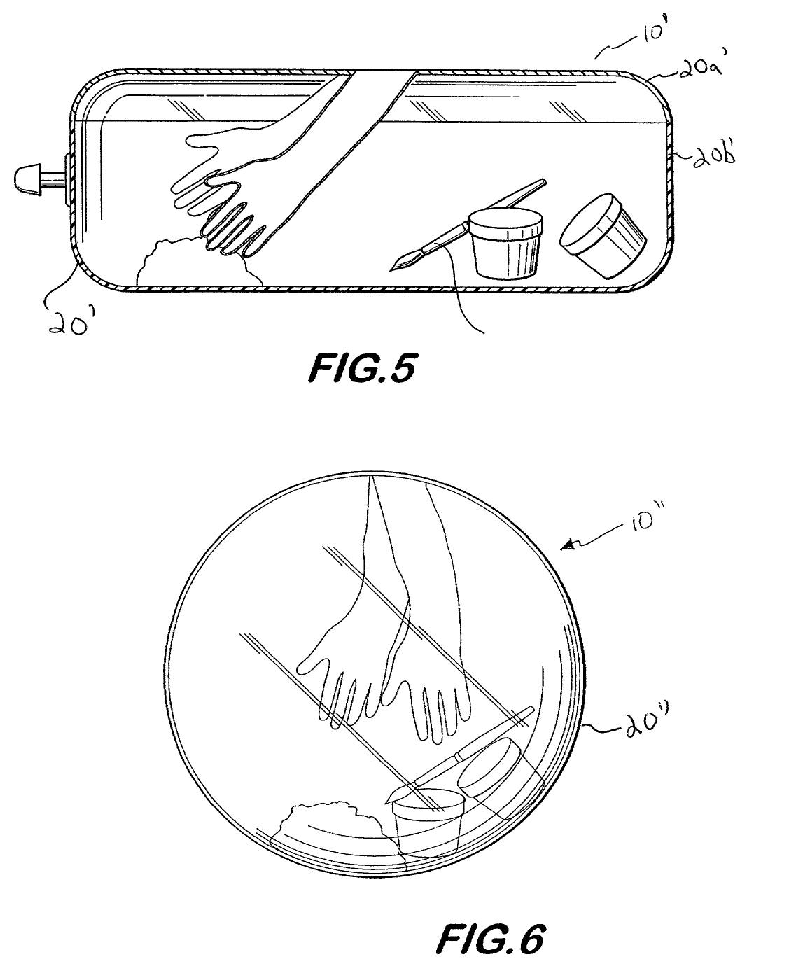

In an alternate embodiment of the chamber 10′ of the present invention, as can be seen in FIG. 5, only a portion of the container 20′ need be made from a flexible material. Here, the upper container walls 20a′ are flexible, while the lower container walls 20b′ are rigid. In the chamber 10′ depicted in FIG. 5, the lower container walls 20b′ of the chamber 10′ may be made from, for example, a rigid plastic that is either opaque or transparent.

As can be seen in another embodiment of the chamber 10″ of FIG. 6, the shape of the container 20″ may be any shape desired, for example, a round ball shape, as shown.

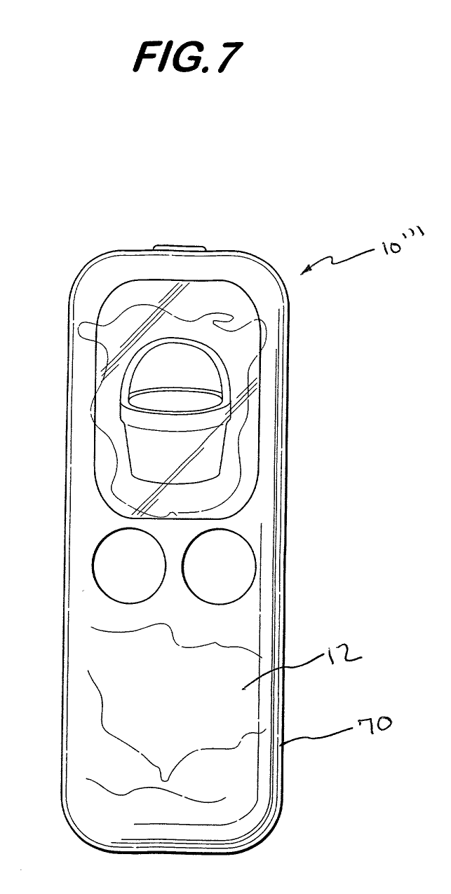

In another alternate embodiment of the present invention as shown in FIG. 7, the chamber 10″′ can include a separate or integral frame 70, such that when the chamber 10″′ is deflated, the frame 70 allows for the container 20″′ to be hung on a wall to display the finished article. Here, a portion of the container 20″′ may be opaque, as shown, to hide the gloves and tools.

Optionally, the gloves 30 and/or the container 20 itself may be made from a cut resistant material to provide some level of protection from injury from the tools or workpiece (e.g. splinters from wood).

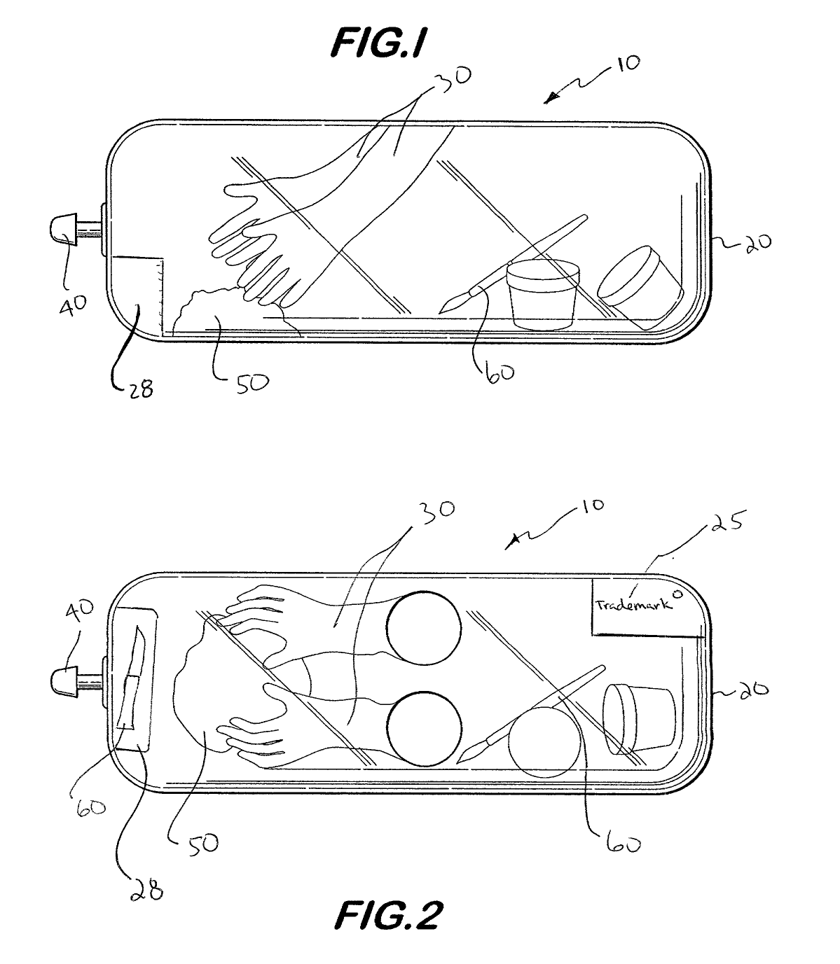

An inner or outer surface of the container 20 may have an area where indicia 25, such as a trademark, may be located. See FIG. 2. Additionally, an integral tool holder 28 may be included in the interior of the container 20 to keep any tools out of the way of the workpiece.

None of the devices in the prior art provides a protective work chamber for arts, crafts, and other messy processes specifically intended for use by children, where all the work materials and tools are enclosed and sealed within the chamber. The present invention is directed to a disposable ball or other shaped chamber that has arts and crafts materials and possibly tools located inside the chamber. One or more gloves are integral to the chamber that protects the hands of the child or artist. The child's or artist's hands are kept clean and the chamber captures and holds all of the debris created by the creative process. The sides and/or top or a portion thereof of the chamber are clear for direct visualization of the work during the project. The chamber may be rigid, collapsible, or partially collapsible. If the chamber is collapsible, the user may inflate it when the user is ready to work on the project. When finished with the project, air within the chamber may be released for storage, shipment, etc. The tools, if any, may be left on the bottom of the chamber or stored in holders integral to the chamber. Once the child or artist has completed the project inside the chamber, the chamber may be cut opened or otherwise opened and the finished project is removed for drying or other finishing steps.

Some of the advantages of the present invention include the following. Use of an inflatable chamber is particularly useful during distribution and storage. Advertising indicia may be placed inside or outside of the chamber on an imprint area such that the chamber may be a “giveaway” at, for example, a fast food restaurant. The present invention is particularly useful for places that must remain relatively clean. Such places may include, for example, a car, plane, sick bed, or hotel room. The chamber may also be useful to contain hazardous odors, such as those emanating from paint or airplane glue. The present invention also enhances a child's ability to focus on his or her own projects when other children are nearby, since distractions may be reduced.

The chamber itself and/or gloves may constructed of a material that offers some protection against injury from sharp tools inside the chamber. The arts and crafts materials may be sealed within the unit (except for an air inlet/valve to allow the chamber to be inflated and possibly deflated) and sold as a single inexpensive unit.

Without further elaboration, the foregoing will so fully illustrate my invention that others may, by applying current or future knowledge, readily adopt the same for use under various conditions of service.

I claim:

1. A protective work chamber for arts, crafts, and other messy processes, comprising:
(a) a container having at least one integral substantially see-through panel and constructed at least partially from a flexible material;
(b) at least one glove having a hand section and an arm section, said arm section sealingly connected to said container; and
(c) said container having arts and crafts materials sealed therein.

2. The protective work chamber of claim 1, wherein the container is constructed substantially entirely from a see-through flexible material.

3. The protective work chamber of claim 1, wherein the container is substantially in the shape of a sphere.

4. The protective work chamber of claim 1, wherein the container is inflatable.

5. The protective work chamber of claim 4, wherein the container has a valve attached to an outer surface of the container for inflation and/or deflation.

6. The protective work chamber of claim 1, wherein the at least one glove includes at least one protective glove that protects against accidental scrapes and cuts.

7. The protective work chamber of claim 1, wherein the container is deflatable for storage, display, and distribution.

8. The protective work chamber of claim 1, wherein the arts and crafts materials include at least one working material.

9. The protective work chamber of claim 8, wherein the at least one working material includes clay.

10. The protective work chamber of claim 8, wherein the at least one working material includes wood.

11. The protective work chamber of claim 8, wherein the at least one working material includes paper.

12. The protective work chamber of claim 1 wherein the arts and crafts materials include paint.

13. The protective work chamber of claim 1, wherein the arts and crafts materials include tools.

14. The protective work chamber of claim 13 wherein the container includes at least one tool holder.

15. The protective work chamber of claim 1, wherein the container is sealed such that the container may be cut open to gain access to the arts and crafts materials.

16. The protective work chamber of claim 1, wherein the container includes an imprint area for indicia.

17. The protective work chamber of claim 1, wherein the container is adapted to contain hazardous odors.

18. The protective work chamber of claim 1, wherein the container is adapted to contain an industrial gas.

19. The protective work chamber of claim 1, wherein the container is at least partially made from a heat shrinkable material.

20. The protective work chamber of claim 1, wherein the container further includes a frame integrally attached to the container, wherein the frame is adapted to be hung on a wall for display.

21. The protective work chamber of claim 1, wherein the container includes a means for maintaining various environmental conditions therein.

22. The protective work chamber of claim 21, wherein the means for maintaining various environmental conditions therein includes a heating element.

23. The protective work chamber of claim 21, wherein the means for maintaining various environmental conditions therein includes a light.

24. A protective work chamber for arts, crafts, and other messy processes, comprising:
(a) a container having at least one integral, substantially see-through panel and constructed substantially from a flexible material, said container being inflatable;
(b) a valve integrally attached to the container, said valve adapted to assist a user in inflating and deflating the container;
(c) at least one glove having a hand section and an arm section, said arm section sealingly connected to said container; and
(d) said container having arts and crafts materials sealed therein.

25. The protective work chamber of claim 24, wherein the container is constructed substantially entirely from a see-through flexible material.

26. The protective work chamber of claim 24, wherein the container is substantially in the shape of a sphere.

27. The protective work chamber of claim 24, wherein the at least one glove includes at least one protective glove that protects against accidental scrapes and cuts.

28. The protective work chamber of claim 24, wherein the arts and crafts materials include at least one working material.

29. The protective work chamber of claim 24, wherein the at least one working material includes clay.

30. The protective work chamber of claim 24, wherein the at least one working material includes wood.

31. The protective work chamber of claim 24, wherein the at least one working material includes paper.

32. The protective work chamber of claim 24, wherein the arts and crafts materials include paint.

33. The protective work chamber of claim 24, wherein the arts and crafts materials include tools.

34. The protective work chamber of claim 33, wherein the container includes at least one tool holder.

35. The protective work chamber of claim 24, wherein the container is sealed such that said container must be cut opened to gain access to the arts and crafts materials.

36. The protective work chamber of claim 24, wherein the container includes an imprint area for indicia.

37. The protective work chamber of claim 24, wherein the container is adapted to contain hazardous odors.

38. The protective work chamber of claim 24, wherein the container is adapted to hold an industrial gas.

39. The protective work chamber of claim 24, wherein the container is at least partially made from a heat shrinkable material.

40. The protective work chamber of claim 24, wherein the container further includes a frame integrally attached to the container, wherein the frame is adapted to be hung on a wall for display.

41. The protective work chamber of claim 24, wherein the container includes a means for maintaining various environmental conditions therein.

42. The protective work chamber of claim 41, wherein the means for maintaining various environmental conditions therein includes a heating element.

43. The protective work chamber of claim 41, wherein the means for maintaining various environmental conditions therein includes a light.
